(19) United States
(12) Patent Application Publication
(10) Pub. No.: US 2014/0175326 A1
(43) Pub. Date: Jun. 26, 2014

(54) SPECIFIC ELECTROLYTIC COMPOSITION FOR ENERGY STORAGE DEVICE

(71) Applicants: Hervé Galiano, La Ville Aux Dames (FR); Bénédicte Montigny, La Riche (FR); Thamra Abdallah, Grenoble (FR); Daniel Lemordant, Vouvray (FR)

(72) Inventors: Hervé Galiano, La Ville Aux Dames (FR); Bénédicte Montigny, La Riche (FR); Thamra Abdallah, Grenoble (FR); Daniel Lemordant, Vouvray (FR)

(73) Assignees: UNIVERSITE FRANCOIS RABELAIS, Tours Cedex (FR); Commissariat a I'energie atomique et aux ene alt, Paris (FR)

(21) Appl. No.: 14/127,344

(22) PCT Filed: Jun. 19, 2012
(86) PCT No.: PCT/EP2012/061735

§ 371 Date: Feb. 12, 2014

(30) Foreign Application Priority Data
Jun. 20, 2011 (FR) 11 55399

(51) Int. Cl. H01G 11/62

(52) U.S. Cl. CPC H01G 11/62
USPC 252/62.2

(57) ABSTRACT

This invention relates to an electrolytic composition comprising at least one organic solvent in which one or several non-lithiated ionic salts are dissolved, characterised in that an ionic liquid is added to this electrolytic composition.

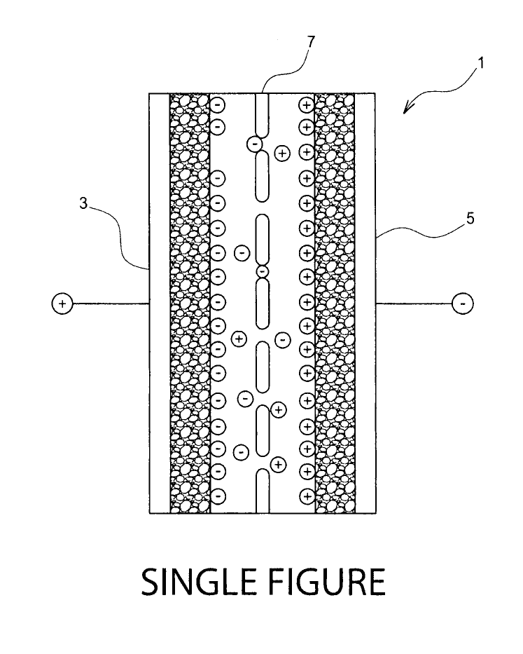

Application to energy storage devices.

### TECHNICAL FIELD

This invention relates to new electrolytic compositions based on organic solvents containing an original combination of ingredients.

These new electrolytic compositions have excellent properties in terms of ionic conductivity, electrochemical window width and safety.

Thus, these electrolytic compositions can be used in applications for the design of energy storage devices such as supercapacitors.

### STATE OF PRIOR ART

Supercapacitors form energy storage devices that can be used to obtain a power density and an energy density intermediate between corresponding values obtained for electrochemical batteries and conventional electrolytic capacitors and also have the special feature that they can restore energy more quickly than is possible with an electrochemical battery.

Thus, supercapacitors have a very particular advantage in the field of onboard energy and also portable energy.

In terms of operation, supercapacitors function based on the principle of the double electrochemical layer which is the reason for the term “Electrochemical Double Layer Capacitor” (EDLC); in other words they are based on the principle of energy storage by distribution of ions originating from an electrolyte in the neighbourhood of the surface of two porous electrodes (usually based on active carbon) impregnated with electrolyte, separated by an insulating porous membrane providing ionic conduction.

Thus, a cell based on a supercapacitor can be summarised as having the following elements:
a positive electrode;
a positive electrode/electrolyte interface forming a double electrochemical layer;
an insulating porous membrane impregnated by said electrolyte;
a negative electrode; and
a negative electrode/electrolyte interface forming a double electrochemical layer.

Due to the existence of these two interfaces each forming a double electrochemical layer, a supercapacitor may be considered schematically as a series combination of two capacitors, one with the positive electrode and the other with the negative electrode, these two capacitors being created by application of a current at the terminals of the supercapacitor, which creates a space charges zone at the two electrode-electrolyte interfaces, the energy being thus stored electrostatically and not electrochemically.

It is known that the energy stored and the power delivered by a supercapacitor vary with the square of the applicable nominal voltage which in other words means that the performances of a supercapacitor can be very much improved by increasing the nominal voltage applicable to the terminals of the supercapacitor. However, to achieve this, the electrolyte sometimes needs a large electrochemical stability window.

Two types of electrolytes have been considered up to now, namely aqueous electrolytes and organic electrolytes.

The nominal applicable voltage range for aqueous electrolytes, regardless of whether they are acid (for example a solution of sulphuric acid) or basic (for example a solution of potash), is limited to about 1 V, which for classical voltages (for example 12 V) makes it necessary to organise complex arrangements of several supercapacitor units.

Organic electrolytes, conventionally consisting of an organic solvent in which ionic salts are dissolved, have a larger electrochemical stability window than aqueous electrolytes. One frequently used organic solvent is acetonitrile. This solvent is not very viscous, it dissolves salts very well and is very dissociating.

Furthermore:
it is very stable, both under oxidising and reducing conditions;
it has a dipolar moment, which enables solvatation of ions;
it has a high donor number and a high acceptor number, such that it can behave both as a Lewis acid and base.

However, despite all its advantages, it does have one major disadvantage which is its volatility and flammability caused by emanation of toxic vapours, which makes it difficult to use it at temperatures of more than 60° C., and which means in particular that it cannot be used in some countries.

However, despite its flammable nature, acetonitrile remains an ideal candidate for the composition of electrolytes, particularly electrolytes for a supercapacitor.

The authors of this invention have centred their research so as to maintain the use of all types of organic solvents in electrolytes containing ionic salts dissolved in said organic solvents while reducing their flammable nature, so that they can be used under high temperature conditions, particularly in supercapacitor types of energy storage devices.

### PRESENTATION OF THE INVENTION

Surprisingly, the authors of this invention discovered that the flammable nature of an organic solvent and thus the composition containing it can be significantly reduced by combining an organic electrolyte (in other words an electrolyte comprising at least one organic solvent in which ionic salts are dissolved) with a particular additive.

This invention thus relates firstly to an electrolytic composition comprising at least one organic solvent in which one or several non-lithiated ionic salts are dissolved, characterised in that an ionic liquid is added to this electrolytic composition.

Note that ionic liquid means salts in the liquid state, these ionic liquids possibly being represented by the following general formula:

A⁺X⁻

in which:
A⁺ represents a cation, usually organic; and
X⁻ represents an anion, usually inorganic.

A non-lithiated ionic salt according to the invention refers to a salt that does not contain any lithium ions as cations, this salt being dissolved in the organic solvent of the electrolytic composition.

The addition of an ionic liquid to an electrolytic composition composed of an ionic salt dissolved in an organic solvent confers the following advantages on the resulting compositions:
a higher flammability limit for the organic solvent, so that these electrolytic compositions can be used under higher temperature conditions than electrolytic compositions without an ionic liquid;
a higher conductivity of the composition;
a wider electrochemical window than is obtained for similar electrolytic compositions without an ionic liquid.

The organic solvent is conventionally an aprotic organic solvent and may be chosen in particular from among nitrile solvents (in other words solvents containing at least one —CN group), carbonate solvents and lactone solvents (in other words solvents comprising at least one cyclic ester group).

When the solvent is a nitrile solvent, it may be acetonitrile with formula CH₃—CN.

Acetonitrile is particularly advantageous for the following reasons:
it is not very viscous (its viscosity being of the order of 0.32 mPa·s);
it dissolves salts very well because it is highly dissociating, making electrolytes comprising acetonitrile into cold conductors;
it is electrochemically stable, both under oxidising and reducing conditions;
its dipolar moment enables solvatation of ions;
it has a high Guttman donor number (of the order of 14) and also a high Guttman acceptor number (of the order of 19) so that it can behave both as an electron acceptor and donor.

When the solvent is a carbonate solvent, it may be propylene carbonate, ethylene carbonate, dimethyl carbonate, ethylmethylcarbonate (or ethyl methyl carbonate known as “EMC”).

When the solvent is a lactone solvent, it may be γ-butyrolactone, β-butyrolactone, γ-valerolactone, δ-valerolactone and γ-caprolactone.

The ionic liquid cation may be a compound comprising at least one nitrogen atom, for which the positive charge is carried by said nitrogen atom, this nitrogen atom possibly belonging to a linear or ramified hydrocarbon chain or to a hydrocarbon cycle.

When the charged nitrogen atom belongs to a linear or ramified hydrocarbon chain, the cation may satisfy the following general formula:

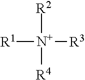

in which R¹, R², R³ and R⁴ represent an alkyl group comprising 1 to 12 carbon atoms.

Specific examples of such cations include N-trimethyl-N-propylammonium, N-hexyl-N-trimethylammonium, N-ethyl-N-dimethyl-N-propylammonium, N-methyl-N-trioctylammonium.

When the charged nitrogen atom belongs to a hydrocarbon cycle, the cation may satisfy one of the following formulas (II) and (III):

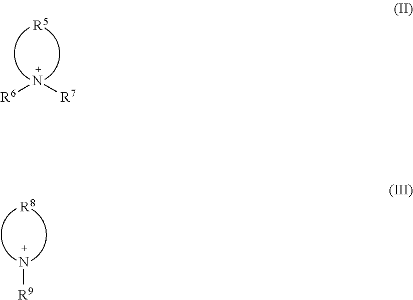

in which:
N⁺ and R⁵ together form an alicyclic group;
N⁺ and R⁸ together form an aromatic group;
R⁶, R⁷ and R⁹ independently represent an alkyl group containing 1 to 12 carbon atoms.

Examples of cations with formula (II) may be:
piperidinium cations, such as the cation with the following formula:

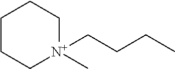

also called N-butyl-N-methylpiperidinium;
pyrrolidinium cations, such as the cation with the following formula:

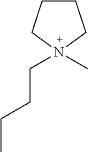

also called N-butyl-N-methylpyrrolidinium.

Specific examples of cations with formula (III) may be:
imidazolium cations, such as the cation with the following formula:

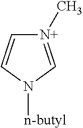

also called 1-n-butyl-3-methylimidazolium;
pyridinium cations, such as the cation with the following formula:

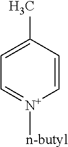

also called 1-n-butyl-4-methylpyridinium.

The ionic liquid anion may be a compound comprising a heteroatom carrying a negative charge, this heteroatom possibly being chosen from among a nitrogen atom or a boron atom.

It may be a perfluorated amidide compound such as a bis(trifluoromethyl-sulfonyl)amidide compound (possibly also called “bis(trifluoromethanesulfonyl)imide”) with the following formula:

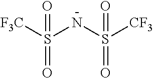 [SMILES: O=S(=O)(NS(=O)(=O)C(F)(F)F)C(F)(F)F]

or a perfluorated borate compound such as a tetrafluoroborate compound with the following formula:

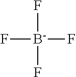

Ionic liquids that can be used in compositions according to the invention may be:
N-trimethyl-N-propylammonium bis(trifluomethanesulfonyl)imide satisfying the following formula:

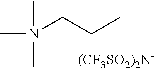

N-butyl-N-methylpiperidinium bis(trifluoromethanesulfonyl)imide satisfying the following formula:

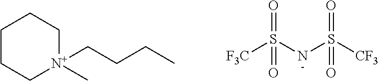

N-butyl-N-methylpyrrolidinium bis(trifluomethanesulfonyl)imide satisfying the following formula:

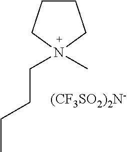

1-n-butyl-3-methylimidazolium tetrafluoroborate satisfying the following formula:

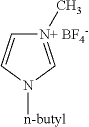

1-n-butyl-4-methylpyridinium tetrafluoroborate satisfying the following formula:

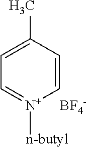

An ionic salt may be an ammonium salt such as tetraethylammonium tetrafluoroborate.

Those skilled in the art will thus make an appropriate choice of the corresponding proportions of the different ingredients used in the compositions according to the invention, so as to obtain good intrinsic conductivity and also to make the composition non-flammable, so that the use of these compositions can be envisaged in energy storage devices, and particularly in supercapacitors.

For example, the ionic salt content of the composition can vary from 0.25 mol/L to 2 mol/L and the content of ionic liquid in the composition can vary from 10% to 20% by mass.

The compositions according to the invention can be prepared by simple preparation processes that can be performed by those skilled in the art.

Thus, the compositions can be prepared following the sequence of steps given below:
a weighing step for each ingredient, namely the organic solvent, the ionic liquid and the ionic salt;
a step in which the composition is formed by adding the ionic liquid in the organic solvent, followed by the addition of ionic salt.

Compositions according to the invention form an electrolytic mixture, the intrinsic conductivity of which is the result of the presence of an ionic salt and an ionic liquid, the ionic liquid also increasing the flammability limit of the organic solvent in compositions according to the invention. The presence of the organic solvent also contributes to making the ionic liquid less viscous and thus making it more capable of impregnating a porous part such as a porous electrode.

Thus, compositions according to the invention are particularly suitable for use as electrolytes in an energy storage device, preferably of the supercapacitor type.

Therefore the invention also relates to an energy storage device, for example of the supercapacitor type as illustrated in a particular embodiment in the single appended FIGURE, comprising at least one cell 1 comprising a positive electrode 3 and a negative electrode 5 separated from each other by a separator 7 comprising an electrolytic composition conforming with the invention.

The positive electrode and the negative electrode may be based on active carbon, in which case supercapacitors comprising this type of electrodes may be qualified as a symmetric system.

The positive electrode and the negative electrode may also be based on metallic oxide(s).

The electrolytic composition forms a double electrochemical layer at each electrode-electrolyte interface.

In particular, one electrolytic composition that is particularly attractive for use in supercapacitors is an electrolytic composition in which the organic solvent is acetonitrile, which introduces the following advantages:
the vapour pressure of acetonitrile is substantially lowered, due to the presence of an ionic liquid and the formation of solvates that are stable with ions in this ionic liquid (particularly when the cation is a pyridinium cation), which has the consequence of reducing the flammability of acetronitrile and thus the mixture containing acetonitrile;
the electrochemical window is very wide (at least 3.5 V), since the presence of the ionic liquid contributes to widening this electrochemical window of acetonitrile;
electrochemical compositions do not crystallise cold and the boiling temperature of the acetonitrile can be exceeded by a wide margin without any substantial vaporisation phenomenon occurring.

Finally, the invention also relates to the use of an ionic liquid in an electrolytic composition comprising an organic solvent and a non-lithiated ionic salt dissolved in said organic solvent to increase the flammability temperature of said composition (in comparison with a composition containing the same organic solvent and the same dissolved non-lithiated ionic salt not containing said ionic liquid).

The ionic liquid, the organic solvent and the non-lithiated ionic salt satisfy the same specific features as those disclosed for the electrolytic compositions defined above.

The invention will now be described with reference to the example given below for illustrative and non-limitative purposes.

### BRIEF DESCRIPTION OF THE DRAWINGS

The single FIGURE shows a supercapacitor cell using an electrolytic composition according to the invention.

### DETAILED PRESENTATION OF PARTICULAR EMBODIMENTS

### EXAMPLE

The compositions tested in this example consist in a ternary mixture comprising:
an organic solvent;
an ionic salt: Et₄NBF_{4;} and
an ionic liquid.

The following ionic liquids are tested for this example:
N-trimethyl-N-propylammonium bis(trifluomethanesulfonyl)imide (symbolically represented by PTMA-TFSI) satisfying the following formula:

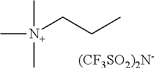

N-butyl-N-methylpiperidinium bis(trifluoromethanesulfonyl)imide (symbolically represented by Pip14-TFSI) satisfying the following formula:

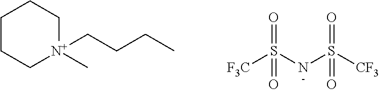

N-butyl-N-methylpyrrolidinium bis(trifluomethanesulfonyl)imide (symbolically represented by P14-TFSI) satisfying the following formula:

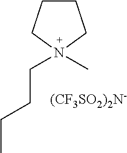

1-n-butyl-3-methylimidazolium tetrafluoroborate (symbolically represented by BMIM-BF4) satisfying the following formula:

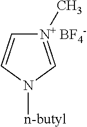

1-n-butyl-4-methylpyridinium tetrafluoroborate (symbolically represented by PyBF₄) satisfying the following formula:

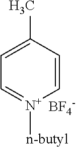

The solvents used are acetonitrile and γ-butyrolactone.

The compositions are subjected to a flammability test by applying a flame to a strip of Manila paper impregnated with the composition up to three-quarters of its height suspended vertically by a clamp and a stand, at a distance very close to the end of the impregnated Manila paper.

If the paper strip ignites in less than three seconds (which is the case for a strip impregnated with pure acetonitrile), the mixture is said to be highly flammable.

If the paper strip ignites after three seconds and then ignites a second time when the test is repeated, the mixture is considered to be flammable.

If the paper strip is not ignited after three seconds and does not ignite a second time when the test is repeated, the mixture is considered to be non-flammable.

In summary, the protocol used can be represented by the following diagram:

The above protocol was used with different mixtures comprising a molar percentage of solvent x and a molar ratio of solvent r (where r is determined by the relation r=x/(1−x)).

The results are given in the following table.

| | BMIM- | | PTMA- | P14- | PiP14- |
|---|---|---|---|---|---|
| | BF4 | Py-BF4 | TFSI | TFSI | TFSI |
| Acetonitrile | In* | In* | In* | In* | In* |
| | r ≦ 4 | r ≦ 6.69 | r ≦ 4 | r ≦ 2.33 | r ≦ 2.33 |
| γ- | In* | In* | In* | In* | In* |
| butyrolactone | r ≦ 1.2 | r ≦ 1.5 | r ≦ 1.2 | r ≦ 1.5 | r ≦ 2.33 |

In* = Non-flammable

It was also observed that mixtures based on acetonitrile have a higher flammability limit than mixtures based on y-butyrolactone, although it might be expected that mixtures based on acetonitrile would be more easily flammable than mixtures based on γ-butyrolactone (considering that γ-butyrolactone is much less volatile than acetonitrile). For example, more than 80% of acetonitrile are necessary to make a mixture based on BMIM-BF4 flammable, while only 55% of γ-butyrolactone is required. Without being dependent on theory, this can be explained by the fact that γ-butyrolactone is a much larger molecule than acetonitrile, and has fewer interactions with the organic cation (despite a comparable donor number). The result is that solvatation of ionic liquid ions is stronger with acetonitrile than with γ-butyrolactone, thus making the mixture with acetonitrile less flammable. Thus, the quantity of solvent immobilised in the ion solvatation layer is high with acetonitrile.

Cyclic voltamperometry measurements were also made with a supercapacitor comprising an acetonitrile/PTMA-TFSI/Et₄N—BF₄ ternary mixture as the electrolyte for a scanning rate of 10 mV/s at 25° C. with a Multi-Channel Potentiostat/Galvanostat VMP type instrument made by Biologic. The result is that the capacitance of the supercapacitor is not affected by the presence of the ionic liquid in comparison with similar tests using an acetonitrile/Et₄N—BF₄ binary mixture as the electrolyte.

1. A method for increasing flammability temperature of an electrolytic composition comprising adding an ionic liquid to the electrolytic composition which comprises an organic solvent in which a non-lithiated ionic salt is dissolved.

2. The method according to claim 1, wherein the ionic liquid comprises a cation comprising a compound comprising a nitrogen atom, for which, a positive charge is carried by the nitrogen atom, and the nitrogen atom is optionally part of a linear or ramified hydrocarbon chain or to a hydrocarbon cycle.

3. The method according to claim 2, wherein when the charged nitrogen atom belongs to a linear or ramified hydrocarbon chain, the cation satisfies formula: 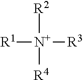
wherein R¹, R², R³ and R⁴ are each independently an alkyl group comprising 1 to 12 carbon atoms.

4. The method according to claim 3, wherein the cation is N-trimethyl-N-propylammonium, N-hexyl-N-trimethylammonium, N-ethyl-N-dimethyl-N-propylammonium or N-methyl-N-trioctylammonium.

5. The method according to claim 3, wherein the cation is N-trimethyl-N-propylammonium.

6. The method according to claim 2, wherein when the charged nitrogen atom belongs to a hydrocarbon cycle, the cation satisfies formula (II) or (III): 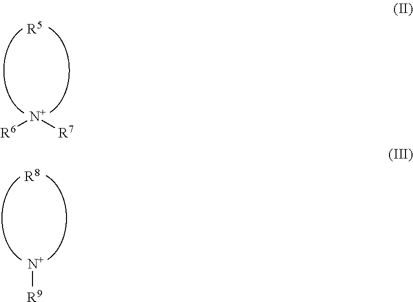
wherein
N+ and R⁵ together form an alicyclic group;
N+ and R⁸ together form an aromatic group; and
R⁶, R⁷ and R⁹ are each independently an alkyl group comprising 1 to 12 carbon atoms.

7. The method according to claim 6, wherein the cation with formula (II) is chosen from among piperidinium cations and pyrrolidinium cations.

8. The method according to claim 7, wherein the cation with formula (II) is a cation of formula: 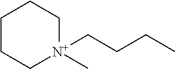
N-butyl-N-methylpiperidinium;
or a cation of formula: 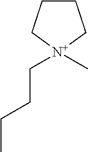
N-butyl-N-methylpyrrolidinium.

9. The method according to claim 6, wherein the cation with formula (III) is chosen from among imidazolium cations and pyridinium cations.

10. The method according to claim 9, wherein the cation with formula (III) is a cation of formula: 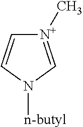
1-n-butyl-3-methylimidazolium;
or a cation of formula: 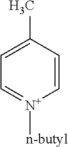
1-n-butyl-4-methylpyridinium.

11. The method according to claim 1, wherein the ionic liquid comprises an anion comprising a compound comprising a heteroatom carrying a negative charge.

12. The method according to claim 11, wherein the heteroatom carrying a negative charge is a nitrogen atom or a boron atom.

13. The method according to claim 11 wherein the anion is a perfluorated amidide compound.

14. The method according to claim 13, wherein the perfluorated amidide is bis(trifluoromethylsulfonyl)amidide of formula:

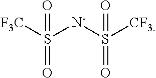 [SMILES: O=S(=O)([N-]S(=O)(=O)C(F)(F)F)C(F)(F)F]

15. The method according to claim 11 wherein the anion is a perfluorated borate compound.

16. The method according to claim 15, wherein the perfluorated borate compound is a tetrafluoroborate of formula:

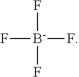

17. The method according to claim 1, wherein the ionic liquid is at least one selected from the group consisting of:
N-trimethyl-N-propylammonium bis(trifluomethanesulfonyl)imide of formula: 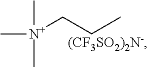
N-butyl-N-methylpiperidinium bis(trifluoromethanesulfonyl)imide of formula: 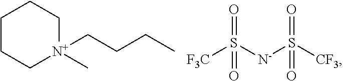
N-butyl-N-methylpyrrolidinium bis(trifluomethanesulfonyl)imide of formula: 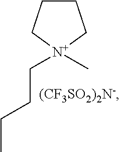
1-n-butyl-3-methylimidazolium tetrafluoroborate of formula: 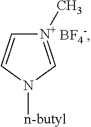
and
1-n-butyl-4-methylpyridinium tetrafluoroborate of formula:

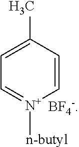

18. The method according to claim 1, wherein the non-lithiated ionic salt is an ammonium salt.

19. The method according to claim 18, wherein the ammonium salt is tetraethylammonium tetrafluoroborate.

20. The method according to claim 1, wherein the organic solvent is an aprotic organic solvent.

21. The method according to claim 1, wherein the organic solvent is chosen from among nitrile solvents, carbonate solvents and lactone solvents.

22. The method according to wherein the organic solvent is acetonitrile.

23. The method according to claim 1, wherein the organic solvent is γ-butyrolactone.

24-26. (canceled)
